(19) United States
(12) Patent Application Publication
(10) Pub. No.: US 2005/0213472 A1
(43) Pub. Date: Sep. 29, 2005

(54) Optical element and optical pickup device having the same

(75) Inventors: Kiyono Ikenaka, Tokyo (JP); Junji Hashimura, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 11/082,550

(22) Filed: Mar. 17, 2005

(30) Foreign Application Priority Data
Mar. 26, 2004 (JP) 2004-093089
Aug. 6, 2004 (JP) 2004-230864

(51) Int. Cl. G11B 7/00

(52) U.S. Cl. 369/112.13

(57) ABSTRACT

This invention provides an optical element which has an optical surface in which a first light beam having a wavelength λx and a second light beam having a wavelength λy, which are emitted from light sources, become incident, including a diffraction structure in which a plurality of zone portions are formed, the zone portions being arranged in a radial direction about an optical axis and forming one period by a plurality of zones formed into a staircase shape divided by steps in a section including the optical axis, wherein the plurality of zone portions of said diffraction structure include a first zone portion and a second zone portion whose numbers of zones in one period are different, and of the plurality of zones which form one period, the zones except the zone which gives a largest optical path length to the passing second light beam have at least two different widths in a direction perpendicular to the optical axis, and of the plurality of zones which form the zone portion, two zones which are adjacent to each other via a step are designed to give no actual phase difference to the first light beam to pass the first light beam and give a phase difference to the second light beam to generate a diffraction effect, and an optical pickup device having the optical element.

This application is based on and claims priorities under 35 U.S.C. §119 from the Japanese Patent Applications Nos. 2004-093089 and 2004-230864 filed in Japan on Mar. 26, 2004 and Aug. 6, 2004, respectively, at least their entire contents are incorporated herein by reference.

### TECHNOLOGICAL FIELD

The present invention relates to an optical element for an optical pickup device and an optical pickup device having the optical element.

### TECHNOLOGICAL BACKGROUND

In recent years, optical pickup devices are required to have compatibility between a plurality of kinds of optical discs (e.g., between a DVD (Digital Versatile Disc) and CD (Compact Disc)).

In addition, as the wavelengths of laser light sources for optical pickup devices shorten, laser light sources with a wavelength of 405 nm have been put into practical use, including a blue-violet semiconductor laser and a blue-violet SHG laser which converts the wavelength of an infrared semiconductor laser by using second harmonic generation.

When such a blue-violet laser light source is used, 15- to -20-GB information can be recorded on an optical disc having a diameter of 12 cm by using an objective lens having the same numerical aperture (NA) as that for a DVD (Digital Versatile Disc). When the NA of the objective lens is increased to 0.85, 23- to 25-GB information can be recorded on an optical disc having a diameter of 12 cm. In this specification, “high-density optical disc” is used as a general term for optical discs and magnetooptical discs using blue-violet laser light sources.

As an optical element used to achieve compatibility between three kinds of optical discs including a high-density optical disc, DVD, and CD with different recording densities or between arbitrary two of them, Japanese Unexamined Patent Publication No. 9-306018 (patent reference 1) discloses a hologram optical element in which a serrate three-dimensional pattern having a staircase shape with a plurality of steps is concentrically formed on the lens surface. In this technique, compatibility between two kinds of optical discs is achieved. by using so-called wavelength selectivity. More specifically, a phase difference is given to one of two light beams which have different wavelengths and pass through the hologram optical element so that the light beam is diffracted. No actual phase difference is given to the other light beam so that it can pass through the hologram optical element.

In techniques disclosed in Japanese Unexamined Patent Publication No. 5-150107 (patent reference 2) and Japanese Unexamined Patent Publication No. 7-113906 (patent reference 3), in association with a technique of approximating a serrate shape serving as a diffraction structure by a staircase shape, i.e., a technique related to so-called staircase approximation of kinoform, the diffraction efficiency is increased by appropriately adjusting the width of the staircase shape. The staircase approximation of kinoform is used conventionally from the viewpoint of lens workability for a purpose different from that of the hologram structure to obtain the wavelength selectivity.

Japanese Unexamined Patent Publication No. 2004-77722 (patent reference 4) discloses a technique related to a Fresnel lens having a wavelength selectivity. This lens includes a diffraction optical element which has a narrow part where the width of the diffraction surface is small and a wide part where the width is large. The number of steps of the stairwise grating in the narrow part is smaller than the number of steps of the stairwise grating in the wide part.

As described above, to achieve compatibility between a plurality of kinds of optical discs having different recording densities, a diffraction structure capable of obtaining a wavelength selectivity as in patent reference 1 is optically formed in the optical element. To do this, a technique to increase the workability of the diffraction structure and also increase the diffraction efficiency of a light beam is necessary. However, the diffraction structure assumed in patent references 2 and 3 has no wavelength selectivity. For this reason, it is difficult to directly use the techniques disclosed in patent references 2 and 3 as a method of designing a diffraction structure with a wavelength selectivity.

Patent reference 1 discloses no technique to increase the workability of a diffraction structure with a wavelength selectivity and the diffraction efficiency.

The technique disclosed in patent reference 4 is associated with the shape of the narrow part formed in a region which is spaced apart from the optical axis and is hard to work. Although any decrease in diffraction efficiency in that region can be prevented, the increase in diffraction efficiency in a region close to the optical axis is not taken into consideration. Hence, it is difficult to ensure the light amount in the entire lens.

### SUMMARY OF THE INVENTION

The present invention has been made in consideration of the above-described problems, and has as its object to provide an optical element which is used for reproducing and/or recording of information for at least two kinds of optical discs, has a diffraction structure with a wavelength selectivity, and can increase the workability and diffraction efficiency, and an optical pickup device having the optical element.

In this specification, “high-density optical disc” is used as a general term for optical discs which use a blue-violet semiconductor laser or blue-violet SHG laser as a light source for recording/reproducing information. The high-density optical discs include an optical disc (e.g., HD or DVD) which records/plays back information by using an objective optical system with an NA of 0.65 to 0.67 and has an about 0.6-mm thick protective layer as well as an optical disc (e.g., blu-ray disc) which records/plays back information by using an objective optical system with an NA of 0.85 and has an about 0.1-mm thick protective layer. In addition to an optical disc having such a protective layer on the information recording surface, the high-density optical discs also include an optical disc having a protective film with a thickness of several to several ten nm on the information recording surface and an optical disc whose protective layer or protective film has a thickness of 0. In this specification, the high-density optical discs also include magnetooptical discs which use a blue-violet semiconductor laser or blue-violet SHG laser as a light source for recording/reproducing information.

In this specification, “DVD” is a general term for optical discs of DVD series such as DVD-ROM, DVD-Video, DVD-Audio, DVD-RAM, DVD-R, DVD-RW, DVD+R, and DVD+RW. “CD” is a general term for optical discs of CD series such as CD-ROM, CD-Audio, CD-Video, CD-R, and CD-RW.

In order to achieve the above object, according to the first aspect of the present invention, there is provided an optical element for use in an optical pickup device which has an optical surface on which a first light beam having a wavelength λx and a second light beam having a wavelength λy, which are emitted from light sources, become incident, comprising a diffraction structure in which a plurality of zone portions are formed, the zone portions being arranged in a radial direction about an optical axis and forming one period by a plurality of zones formed into a staircase shape divided by steps in a section including the optical axis, wherein the plurality of zone portions of the diffraction structure include a first zone portion and a second zone portion whose numbers of zones in one period are different, and of the plurality of zones which form one period, the zones except the zone which gives a largest optical path length to the passing second light beam have at least two different widths in a direction perpendicular to the optical axis, and of the plurality of zones which form the zone portion, two zones which are adjacent to each other via a step are designed to give no actual phase difference to the first light beam to pass the first light beam and give a phase difference to the second light beam to generate a diffraction effect.

According to the second aspect of the present invention, there is provided an optical element for use in an optical pickup device, comprising a diffraction structure in which at least two light beams (a first light beam having a wavelength λX and a second light beam having a wavelength λY) become incident when the optical pickup device is used, wherein the diffraction structure is so arranged as to cause the second light beam to generate a diffraction effect by giving the second light a phase difference, wherein the diffraction structure is comprised of a plurality of zone portions which are periodically formed in a radial direction about an optical axis, a plurality of zones having a staircase shape in a section including the optical axis are formed in each zone portion, wherein a depth d of two zones which are adjacent to each other in each zone portion in a direction of the optical axis is given by
0.96×mX×λX/(nX−1)≦d≦1.04×mX×λX/(nX−1) (1)
where mX: positive integer

nX: refractive index of the optical element for the first light beam having the wavelength λX, wherein the plurality of zone portions comprising the diffraction structure includes a first zone portion and a second zone portion in which the number of zones formed in one zone portion differ from those in the first zone portion, and wherein a zone portion is present in which, out of the plurality of zones formed in one zone portion of the diffraction structure, the zones except the zone which gives a largest optical path length to the passing second light beam have at least two different widths in a direction perpendicular to the optical axis.

According to the optical element of the second aspect, the diffraction structure has a wavelength selectivity to give the diffraction effect to the first light beam but not to the second light beam. Hence, a compatible optical pickup device which ensures a sufficient light amount and has an aberration correction function can be obtained even when no diffraction structure is formed in another element (e.g., objective lens) included in the optical system of the optical pickup device.

In addition, the number of zones present in one zone portion of the diffraction structure changes depending on the zone portion. For this reason, the zone width can be selected, unlike a structure in which all zone portions include zones in equal number. Hence, even an optical element having a function which is conventionally unavailable because of restrictions in work can be worked.

According to the third aspect of the present invention, there is provided the optical element of the first aspect, wherein when of the plurality of zones present in one zone portion of the diffraction structure, the zone which gives the largest optical path length to the passing second light beam is defined as a first zone, the number of zones present between the first zones present in two adjacent zone portions changes depending on the zone portion.

According to the optical element of the third aspect, the number of zones present between the first zones present in two adjacent zone portions changes depending on the zone portion. For this reason, the zone width can be selected, unlike a structure in which all zone portions include zones in equal number. Hence, even an optical element having a function which is conventionally unavailable because of restrictions in work can be worked.

According to the fourth aspect of the present invention, there is provided an optical element for use in an optical pickup device, comprising a diffraction structure in which at least one light beam becomes incident when the optical pickup device is used, wherein the diffraction structure is so arranged as to cause the second light beam to generate a diffraction effect, without transmitting as it is, by giving the second light a phase difference, wherein the diffraction structure is comprised of a plurality of zone portions which are periodically formed in a radial direction about an optical axis, a plurality of zones having a staircase shape in a section including the optical axis are formed in each zone portion, and wherein the plurality of zone portions comprising the diffraction structure includes a first zone portion and a second zone portion in which the number of zones formed in one zone portion differ from those in the first zone portion, the first and second zone portions being periodically mixed.

According to the optical element of the fourth aspect, at least two kinds of structures, i.e., a structure in which the number of zones present in one zone portion is Al (e.g., 5) and a structure in which the number of zones is A2 (A2≠A1, e.g., 4) are periodically mixed. For example, a zone portion having four zones follows a zone portion having five zones, and this combination is periodically repeated. With this arrangement, the order of diffraction of diffracted light having the maximum diffraction efficiency of the light beams incident in the diffraction structure can appropriately be adjusted. Hence, the degree of freedom in designing the lens increases.

According to the fifth aspect of the present invention, there is provided the optical element of the fourth aspect, wherein a zone portion A is present in which of the plurality of zones present in one zone portion of the diffraction structure, the zones except the zone which gives a largest optical path length to the passing light beam have at least two different widths in a direction perpendicular to the optical axis.

According to the sixth aspect of the present invention, there is provided an optical element for use in an optical pickup device, comprising a diffraction structure in which at least one light beam becomes incident when the optical pickup device is used, wherein the diffraction structure is so arranged as to cause the second light beam to generate a diffraction effect, without transmitting as it is, by giving the second light a phase difference, wherein the diffraction structure is comprised of a plurality of zone portions which are periodically formed in a radial direction about an optical axis, a plurality of zones having a staircase shape in a section including the optical axis are formed in each zone portion, and zone portions of the plurality of zone portions are periodically present as zones about the optical axis, and when of the plurality of zone portions, a period width of a zone portion having a smallest period width in a direction perpendicular to the optical axis is defined as L, the zone which gives a largest optical path length to the passing light beam is defined as a first zone, a width of the first zone in the direction perpendicular to the optical axis is defined as ΔL, and the number of zones present in the zone portion is defined as K,
1/K<ΔL/L≦1/(K−1) (2)
is satisfied.

According to the optical element of the sixth aspect, the width ΔL of the first zone in the direction perpendicular to the optical axis is made larger than those of the remaining zones. In this case, in working a die by using a flat cutting tool, a space to move the cutting tool in the direction of the optical axis at a portion corresponding to the first zone and, when the die is carved in a predetermined amount, slidably move the cutting tool to form a portion corresponding to the optical surface of the first zone can be ensured. Hence, the first zone can be worked. In addition, the decrease in light amount can be suppressed as compared to a case in which the number of zones formed in one zone portion is decreased to increase the width ΔL.

According to the seventh aspect of the present invention, there is provided the optical element of the sixth aspect, wherein a zone portion A is present in which of the plurality of zones present in one zone portion of the diffraction structure, the zones except the zone which gives the largest optical path length to the passing light beam have at least two different widths in the direction perpendicular to the optical axis.

According to the eighth aspect of the present invention, there is provided the optical element of the first aspect, wherein when the widths of the zones present in the zone portion A in the direction perpendicular to the optical axis are defined as T1, T2, T3, . . . , Ti (i is a natural number) sequentially from a side close to the optical axis, T1>T2>T3> . . . >Ti.

According to the ninth aspect of the present invention, there is provided the optical element of the eighth aspect, wherein letting h be a height of each zone from the optical axis, the width Ti of each zone present in the zone portion A in the direction perpendicular to the optical axis is given by Ti∝[d(ΣC₂ᵢh²ⁱ)/dh]⁻¹ (C₂ᵢ is a coefficient of an optical path difference function).

According to the optical element of the seventh aspect, the widths of the zones present in the zone portion A in the direction perpendicular to the optical axis are defined as T1, T2, T3, . . . , Ti sequentially from the side close to the optical axis, and T1>T2>T3> . . . >Ti is set. Alternatively, as in the eighth aspect, letting h be the height of each zone from the optical axis, the width Ti of each zone present in the zone portion A in the direction perpendicular to the optical axis is given by Ti∝[d(ΣC₂ᵢh²ⁱ)/dh]⁻¹. With this arrangement, in the zone portion close to the optical axis, the width of each zone decreases in inverse proportion to h. The diffraction efficiency can be increased as compared to a case in which the widths of all zones are set equal.

Normally, the width of the zone portion closest to the optical axis is larger than the remaining zone portions. Light which passes through this zone portion largely contributes to the entire light. As in the ninth embodiment, the zone portion A is set as the zone portion closest to the optical axis of the plurality of zone portions. In this case, the distribution of the widths of the zones can be made close to Ti∝1/h, and the shift between the phase function and the actually given phase difference can be decreased.

According to the 10th aspect of the present invention, there is provided the optical element of the first aspect, wherein the zone portion A is closest to the optical axis in the plurality of zone portions.

According to the 11th aspect of the present invention, there is provided the optical element of the first aspect, wherein when, in one zone portion, the width of the zone, which gives the largest optical path length to the passing light beam, in the direction perpendicular to the optical axis is defined as ΔL1, and the width of the remaining zones in the direction perpendicular to the optical axis is defined as ΔL′, at least two zone portions which satisfy ΔL′<ΔL1<2ΔL′ are present in the diffraction structure.

According to the optical element of the 11th aspect, of the plurality of zone portions of the diffraction structure, for the zone portion spaced apart from the optical axis, in one zone portion, the width of the zone, which gives the largest optical path length to the passing light beam, in the direction perpendicular to the optical axis is defined as ΔL1, and the width of the remaining zones in the direction perpendicular to the optical axis is defined as ΔL′. In this case, at least two zone portions which satisfy ΔL′<ΔL1<2ΔL′ are present in the diffraction structure. With this arrangement, the diffraction efficiency can be increased even in the region close to the optical axis.

According to the 12th aspect of the present invention, there is provided the optical element of the sixth aspect, wherein when, in one zone portion, the width of the zone, which gives the largest optical path length to the passing light beam, in the direction perpendicular to the optical axis is defined as ΔL1, and the width of the remaining zones in the direction perpendicular to the optical axis is defined as ΔL′, a zone which satisfies ΔL1<ΔL′ and a zone which satisfies ΔL1=ΔL′ are mixed.

As in the 12th aspect, when the width of each zone is set to be given an optical path difference along the optical path difference function, the highest diffraction efficiency can be obtained. However, when each zone width is smaller than the width of the working tool and, more particularly, when the width of the uppermost zone (zone which gives the largest optical path length to the passing light beam) is smaller than the working tool, manufacturing is impossible. Hence, the zone of the uppermost zone must always be set larger than a predetermined width. However, the pitch is normally large in the region close to the optical axis. In the ideal diffraction shape, the width of the uppermost zone is much larger than the predetermined width.

In one zone portion, when the zone which gives the largest optical path length is spaced apart from the optical axis, ΔL1<ΔL′ for the ideal shape according to the phase function holds in the zone portion close to the optical axis. When the phase function is proportional to h in the zone portion spaced apart from the optical axis, and no problem in working is posed, all zone widths become equal so that ΔL1=ΔL′ holds.

Conversely, in one zone portion, when the zone which gives the largest optical path length is closer to the optical axis than the remaining zones, all zone widths become equal so that ΔL1=ΔL′ holds if the phase function is proportional to h in the zone portion spaced apart from the optical axis, and no problem in working is posed. When the zone portion is farther from the optical axis, and working is impossible if all zone widths are set equal, ΔL1<ΔL′ preferably holds.

According to the 13th aspect of the present invention, there is provided the optical element of the first aspect, wherein of diffracted light components generated by the diffraction structure when the first light beam having the wavelength λX becomes incident, 0th-order diffracted light has a maximum diffraction efficiency, and of diffracted light components generated by the diffraction structure when the second light beam having the wavelength λY becomes incident, diffracted light except 0th-order diffracted light has the maximum diffraction efficiency.

According to the 14th aspect of the present invention, there is provided the optical element of the 13th aspect, wherein the diffraction structure is optimized for the 0th-order diffracted light of the first light beam.

According to the 15th aspect of the present invention, there is provided the optical element of the first aspect, wherein the diffraction structure satisfies
620 nm≦λX≦690 nm
750 nm≦λY≦820 nm
m1=1
   and has at least one zone portion group including six zone portions.

According to the 16th aspect of the present invention, there is provided the optical element of the 15th aspect, wherein of diffracted light components generated by the diffraction structure when the first light beam having the wavelength λX becomes incident, 0th-order diffracted light has a maximum diffraction efficiency, of diffracted light components generated by the diffraction structure when the second light beam having the wavelength λY becomes incident, diffracted light except 0th-order diffracted light has the maximum diffraction efficiency, and the diffraction efficiencies fall within a range of 75% to 100%.

According to the 17th aspect of the present invention, there is provided the optical element of the 15th aspect, wherein 0.0012 mm≦d≦0.0014 mm is satisfied.

According to the 18th aspect of the present invention, there is provided the optical element of the first aspect, wherein a third light beam having a wavelength λZ further enters the diffraction structure when the optical pickup device is used,
370 nm≦λX≦440 nm
750 nm≦λY≦820 nm
620 nm≦λZ≦690 nm
m1=5
   are satisfied, and the diffraction structure has at least one zone portion group including two zone portions.

According to the 19th aspect of the present invention, there is provided the optical element of the 18th aspect, wherein of diffracted light components generated by the diffraction structure when the first light beam having the wavelength λX becomes incident, 0th-order diffracted light has a maximum diffraction efficiency, of diffracted light components generated by the diffraction structure when the second light beam having the wavelength λY becomes incident, diffracted light except 0th-order diffracted light has the maximum diffraction efficiency, of diffracted light components generated by the diffraction structure when the third light beam having the wavelength λZ becomes incident, 0th-order diffracted light has the maximum diffraction efficiency, the diffraction efficiencies associated with the light beam having the wavelength λX and the light beam having the wavelength λZ fall within a range of 75% to 100%, and the diffraction efficiencies associated with the light beam having the wavelength λY fall within a range of 30% to 100%.

According to the 20th aspect of the present invention, there is provided the optical element of the 18th aspect, wherein 0.0076 mm≦d≦0.0086 mm is satisfied.

According to the 21st aspect of the present invention, there is provided the optical element of the sixth aspect, wherein 0.005 mm≦ΔL≦0.015 mm is satisfied.

According to the 22nd aspect of the present invention, there is provided the optical element of the fourth aspect, wherein at least the first light beam having the wavelength λX and the second light beam having the wavelength λY enter the diffraction structure, of diffracted light components generated by the diffraction structure when the first light beam having the wavelength λX becomes incident, 0th-order diffracted light has a maximum diffraction efficiency, and of diffracted light components generated by the diffraction structure when the second light beam having the wavelength λY becomes incident, diffracted light except 0th-order diffracted light has the maximum diffraction efficiency.

According to the 23rd aspect of the present invention, there is provided the optical element of the fourth aspect, wherein a wavelength of the light beam which enters the diffraction structure and receives the diffraction effect falls within a range of 750 nm to 820 nm.

According to the 24th aspect of the present invention, there is provided the optical element of the fourth aspect, wherein a wavelength of the light beam which enters the diffraction structure and receives the diffraction effect falls within a range of 620 nm to 690 nm.

According to the 25th aspect of the present invention, there is provided the optical element of the fourth aspect, wherein at least the first light beam having the wavelength λX and the second light beam having the wavelength λY enter the diffraction structure, and the second light beam receives the diffraction effect by the diffraction structure, and of diffracted light components generated by the diffraction structure when the second light beam having the wavelength λY becomes incident, 0th-order diffracted light has a maximum diffraction efficiency.

According to the 26th aspect of the present invention, there is provided the optical element of the first aspect, wherein the optical element main body is formed from a material whose Abbe number for the d line falls within a range of 40 to 60.

According to the 27th aspect of the present invention, there is provided the optical element of the first aspect, wherein an angle α of a surface which connects the optical surfaces of adjacent zones with respect to an incident direction of a light beam having a wavelength λ1 satisfies 0°≦α≦10°.

The surface which connects the optical surfaces of the adjacent zones is preferably parallel to the incident direction of the light beam. However, when convergent light or divergent light enters the diffraction structure, the incident direction changes depending on the height from the optical axis. To make the incident directions parallel in all zones, the angle of the surface which connects the optical surfaces of the zones must be changed for each zone. From the viewpoint of workability, to obtain a shape to prevent any decrease in diffraction efficiency even when the surfaces which connect the optical surfaces of zones have a predetermined angle in all zones, the angle α (FIG. 3B) of the surface which connects the optical surfaces of adjacent zones with respect to the incident direction of the light beam having the wavelength λ1 preferably falls within the above range, as in the optical element of the 27th aspect.

According to the 28th aspect of the present invention, there is provided the optical element of the first aspect, wherein letting R be a curvature of the optical surface on which the zone of the optical element is formed in a state without the diffraction structure, and f1 be a focal length for a light beam having a shortest wavelength of the light beams incident on the objective lens, −1.5 mm≦−f1/R≦1.5 mm is satisfied.

When at the same height from the optical axis, the difference between the normal angle to the surface in the state without the diffraction structure and the normal angle to the optical surface of the zone becomes large, the wavefront aberration increases. However, from the viewpoint of die working, the normal angle to the optical surface of the zone is preferably constant in all zones. As in the optical element of the 28th aspect, when the curvature of the surface without the diffraction structure is relaxed, the decrease in diffraction efficiency can be suppressed. In addition, the zone can be worked only by moving the flat cutting tool having a blade angle of about 90° vertically with respect to the optical axis.

According to the 29th aspect of the present invention, there is provided the optical element of the 28th aspect, wherein the optical surface of the zone is flat.

The surface which connects the optical surfaces of the adjacent zones is preferably parallel to the incident direction of the light beam. However, when convergent light or divergent light enters the diffraction structure, the incident direction changes depending on the height from the optical axis. For optimization, the angle of the surface which connects the optical surfaces of the zones must be changed for each zone. From the viewpoint of workability, to obtain a shape to prevent any decrease in diffraction efficiency even when the surfaces which connect the optical surfaces of zones have a predetermined angle in all zones, the optical surface of the zone is preferably flat, as in the optical element of the 29th aspect.

According to the 30th aspect of the present invention, there is provided the optical element of the 28th aspect, wherein an incident angle of the light beam having the wavelength λX with respect to a normal to the optical surface of each zone falls within a range of 0° to 10°.

As in the optical element of the 30th aspect, when the curvature of the optical surface of the zone is relaxed (almost perpendicular to the optical axis), and the incident angle of the light beam with respect to the normal angle to the optical surface is set to 0° to 10°, the surface which connects the optical surfaces of the adjacent zones is preferably perpendicular to the zone surface. The zone can be worked only by moving the flat cutting tool having a blade angle of about 90° vertically with respect to the optical axis.

According to the 31st aspect of the present invention, there is provided the optical element of the first aspect, wherein the optical element comprises an objective lens included in an optical system of the optical pickup device.

According to the 32nd aspect of the present invention, there is provided the optical element of the first aspect, wherein the optical element comprises a coupling lens included in an optical system of the optical pickup device.

According to the 33rd aspect of the present invention, there is provided the optical element of the 32nd aspect, wherein the diffraction structure is formed on an optical surface of the optical element on a side of the light source.

According to the 34th aspect of the present invention, there is provided the optical element of the first aspect, wherein when a wavelength of a light beam which enters the diffraction structure and receives no diffraction effect from the diffraction structure is defined as λZ, and a depth d of two adjacent zones in each zone portion of the diffraction structure is given by
0.96×mZ×λZ/(nZ−1)≦D≦1.04×mZ×λZ/(nZ−1) (3)
where mZ: positive integer, nZ: refractive index of the optical element for the light beam having the wavelength λZ,

a zone having mZ which changes depending on the zone portion of the diffraction structure is present.

According to the 35th aspect of the present invention, there is provided the optical element of the first aspect, wherein the optical element main body is formed by stacking a material A and material B, which have different Abbe numbers for the d line, and the diffraction structure is formed at an interface between the material A and the material B.

According to the 36th aspect of the present invention, there is provided the optical element of the first aspect, wherein a third light beam having a wavelength λZ further enters the diffraction structure when the optical pickup device is used,
370 nm≦λX≦440 nm
750 nm≦λY≦820 nm
620 nm≦λZ≦690 nm
   are satisfied, of diffracted light components generated by the diffraction structure when the first light beam having the wavelength λX becomes incident, 0th-order diffracted light has a maximum diffraction efficiency, of diffracted light components generated by the diffraction structure when the second light beam having the wavelength λY becomes incident, 0th-order diffracted light has the maximum diffraction efficiency, of diffracted light components generated by the diffraction structure when the third light beam having the wavelength λZ becomes incident, diffracted light except 0th-order diffracted light has the maximum diffraction efficiency, and the diffraction efficiencies associated with the light beams having the wavelengths λX, λY, and λZ fall within a range of 60% to 100%.

According to the 37th aspect of the present invention, there is provided an optical pickup device comprising the optical element of any one of the first, second, fourth, and sixth aspects.

As is apparent from the above-described aspects, according to the present invention, an optical element which is used for reproducing and/or recording of information for at least two kinds of optical discs, has a diffraction structure with a wavelength selectivity, and can increase the workability and diffraction efficiency, and an optical pickup device having the optical element can be obtained.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a schematic plan view showing the arrangement of the main part of an optical pickup device according to the first embodiment of the present invention;

FIG. 2 is a plan view showing a diffraction structure;

FIGS. 3A and 3B are enlarged views showing the diffraction structure;

FIG. 4 is a graph showing the relationship between a phase function and a phase difference;

FIGS. 5A to 5E are graphs showing the relationship between the phase function and the phase difference; and

FIG. 6 is a schematic plan view showing the arrangement of the main part of an optical pickup device according to the second embodiment of the present invention.

### DETAILED DESCRIPTION OF THE PREFERRED EMBODIMENTS

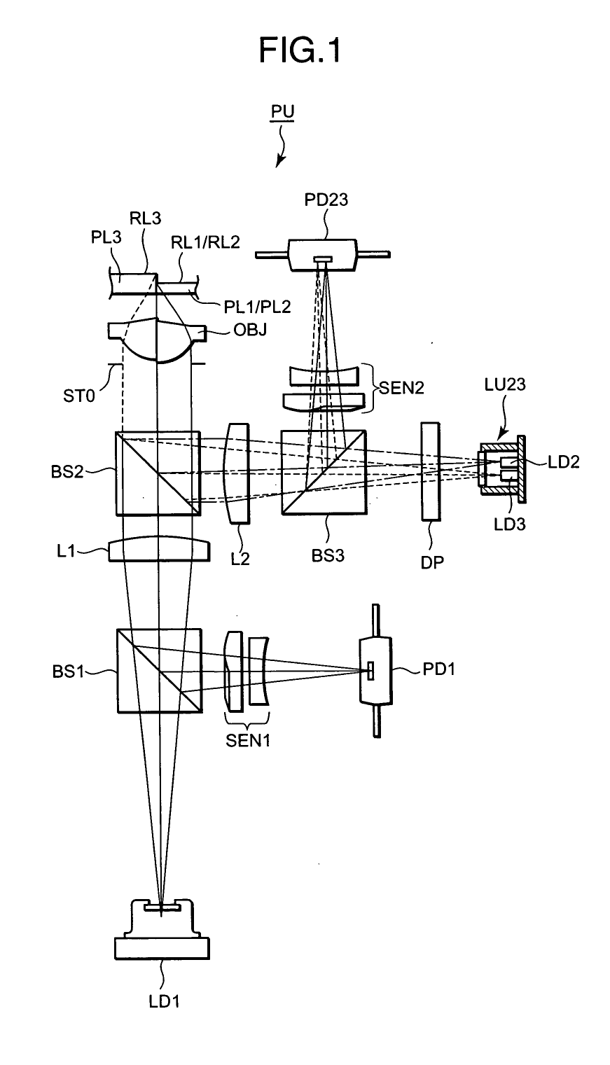

The first embodiment of the present invention will be described first in detail with reference to the accompanying drawings (FIGS. 1 to 5E).

FIG. 1 is a plan view schematically showing the arrangement of an optical pickup device PU which can appropriately record/reproduce information on/from all of a first optical disc AOD (Advanced Optical Disc), second optical disc DVD (Digital Versatile Disc), and third optical disc CD (Compact Disc). The optical specifications of the AOD include a wavelength λ1=407 nm, a thickness t1 of a protective layer (protective substrate) PL1 is 0.6 mm, and an numerical aperture NA1 is 0.65. The optical specifications of the DVD include a wavelength λ2=655 nm, a thickness t2 of a protective layer (protective substrate) PL2 is 0.6 mm, and an numerical aperture NA2 is 0.65. The optical specifications of the CD include a wavelength λ3=785 nm, a thickness t3 of a protective layer PL3 is 0.6 mm, and an numerical aperture NA3 is 0.51.

However, the combination of the wavelengths, protective layer thicknesses, and numerical apertures is not limited to this. As the first optical disc, a high-density optical disc whose protective layer PL1 has the thickness t1 of about 0.1 mm may be used.

The optical pickup device PU includes a blue-violet semiconductor laser LD1 (first light source) which emits a 407-nm laser beam (first light beam having the wavelength λ1) in recording/playing back information on/from the AOD, a photodetector PD1 for the first light beam, a light source unit LU23 in which a red semiconductor laser LD2 (second light source) which emits a 655-nm laser beam (second light beam having the wavelength λ2) in recording/playing back information on/from the DVD and an infrared semiconductor laser LD3 (third light source having the wavelength λ3) which emits a 785-nm laser beam (third light beam) in recording/playing back information on/from the CD are integrated, a photodetector PD23 common to the second and third light beams, a first collimator L1 which passes only the first light beam, a second collimator L2 (optical element of the present invention) which passes the second and third light beams, an objective optical element OBJ which has a function of focusing the laser beams on information recording surfaces RL1, RL2, and RL3, a first beam splitter BS1, a second beam splitter BS2, a third beam splitter BS3, a stop STO, and sensor lenses SEN1 and SEN2.

A diffraction structure (to be described later in detail) is formed on an incident optical surface S1 of the second collimator L2. Of the second and third light beams, the diffraction structure gives an actual phase difference to the third light beam but not to the second light beam to generate a diffraction effect. No diffraction structure is formed on the optical surface of the objective optical element OBJ. Its optical surface is simply formed from a refraction surface.

The wavelength selecting function of the second collimator L2 in the optical pickup device PU shown in FIG. 1 will be described next.

To record/reproduce information on/from the AOD, first, the blue-violet semiconductor laser LD1 is caused to emit light in accordance with the light beam path indicated by the solid line in FIG. 1. The first light beam with the wavelength λ1, which is emitted from the blue-violet semiconductor laser LD1, passes through the first beam splitter BS1 and reaches the first collimator L1.

The first light beam is converted into a parallel beam when passing through the first collimator L1. The first light beam then passes through the second beam splitter BS2 and reaches the objective optical element OBJ.

The first light beam is given the refracting effect by the refraction surface of the objective optical element OBJ and is focused on the information recording surface RL1 through the protective layer PL1 of the AOD to form a spot.

In the objective optical element OBJ, focusing or tracking is done by a biaxial actuator AC (not shown) arranged near the objective optical element OBJ. The reflected light beam modulated by information pits on the information recording surface. RL1 passes through the objective optical element OBJ, second beam splitter BS2, and first collimator L1 again. The light beam is split by the first beam splitter BS1, given astigmatism by the sensor lens SEN1, and focused on the light-receiving surface of the photodetector PD1. The information recorded on the AOD can be read by using the output signal from the photodetector PD1.

To record/reproduce information on/from the DVD, first, the red semiconductor laser LD2 is caused to emit light in accordance with the light beam path indicated by the alternate long and short dashed line in FIG. 1. The second light beam with the wavelength λ2, which is emitted from the red semiconductor laser LD2, passes through the third beam splitter BS3 and reaches the second collimator L2.

The second light beam is converted into a parallel beam when passing through the second collimator L2. The second light beam is reflected by the second beam splitter BS2 and reaches the objective optical element OBJ.

The second light beam is given the refracting effect by the refraction surface of the objective optical element OBJ and is focused on the information recording surface RL2 through the protective layer PL2 of the DVD to form a spot.

In the objective optical element OBJ, focusing or tracking is done by the biaxial actuator AC arranged near the objective optical element OBJ. The reflected light beam modulated by information pits on the information recording surface RL2 passes through the objective optical element OBJ, second beam splitter BS2, and second collimator L2 again. The light beam is split by the third beam splitter BS3 and focused on the light-receiving surface of the photodetector PD23. The information recorded on the DVD can be read by using the output signal from the photodetector PD23.

To record/reproduce information on/from the CD, first, the infrared semiconductor laser LD3 is caused to emit light in accordance with the light beam path indicated by the dotted line in FIG. 1. The third light beam with the wavelength λ3, which is emitted from the infrared semiconductor laser LD3, passes through the third beam splitter BS3 and reaches the second collimator L2.

The diffracted light of the third light beam, which has a predetermined order and is generated by the diffraction effect of the diffraction structure when the light beam passes through the second collimator L2, is converted into a divergence angle smaller that in the incident time and emerges from the second collimator L2.

The third light beam which has emerged from the second collimator L2 is reflected by the second beam splitter BS2 and reaches the objective optical element OBJ.

The third light beam is given the refracting effect by the refraction surface of the objective optical element OBJ and focused on the information recording surface RL3 through the protective layer PL3 of the CD to form a spot. The chromatic aberration of the third focusing spot is suppressed within the range necessary for reproducing and/or recording information.

In the objective optical element OBJ, focusing or tracking is done by the biaxial actuator AC arranged near the objective optical element OBJ. The reflected light beam modulated by information pits on the information recording surface RL3 passes through the objective optical element OBJ, second beam splitter BS2, and second collimator L2 again. The light beam is split by the third beam splitter BS3 and focused on the light-receiving surface of the photodetector PD23. The information recorded on the CD can be read by using the output signal from the photodetector PD23.

The diffraction structure (to be referred to as a “diffraction structure HOE” hereinafter) formed on the incident optical surface S1 of the second collimator L2 will be described next.

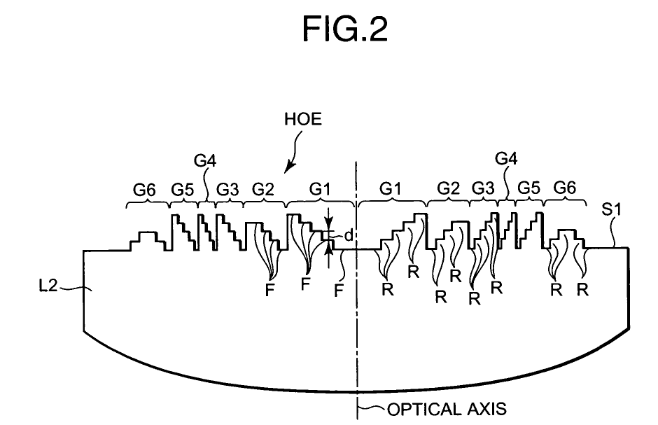

As shown in FIG. 2, the diffraction structure HOE comprised of a plurality of zone portions, each having a plurality of concentric zones R, which are periodically formed on an incident optical surface S1 of the second collimator L2 about the optical axis are arranged. The section of the plurality of zones R taken along a plane including the optical axis has a staircase shape. In addition, the plurality of zones R are separated stepwise at every period where a phase allowance for an incident light beam is zero with respect to the light beam subjected to the diffraction effect. In the embodiment shown in FIG. 2, there are provided six zone portions G1 to G6.

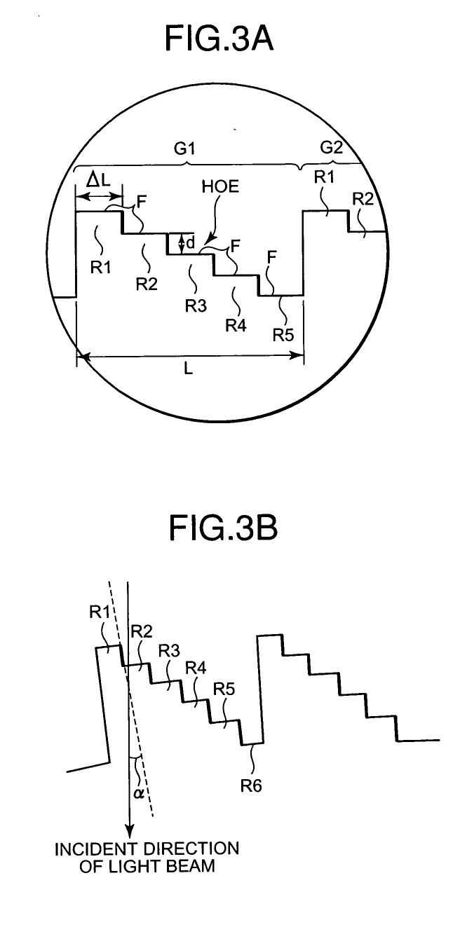

In each of the zone portions G1 to G6, a depth d in the direction of the optical axis between optical surfaces F of two adjacent zones R (see FIG. 3A showing the zone portion G1) is given by the following formula:
0.96×m2×λ2/(n2−1)≦d≦1.04×m2×λ2/(n2−1) (1)
m2: positive integer, n2: refractive index of the optical element for the second light beam with the wavelength λ2, In this case, λ2 represents the wavelength of the laser beam emitted from the red semiconductor laser LD2 by μm (λ2=0.655 μm).

The number of zones R present in one zone portion changes depending on the zone portion. In other words, of the plurality of zones R present in one zone portion, the zone which gives the largest optical path length to the second light beam which passes is defined as a first zone R1 (FIG. 3A). At this time, the number of zones R present between the first zones of two adjacent zone portions (e.g., G1 and G2) changes depending on the zone portion (for example, referring to FIG. 2, the number of zones present between the first zone of the zone portion G1 and that of the zone portion G2 is 4, and the number of zones present between the first zone of the zone portion G2 and that of the zone portion G3 is 5).

The zones except the first zone R1 in the zone portion G1 (zone portion A) have two or more different widths in the direction perpendicular to the optical axis.

When the laser beam having the wavelength λ2 enters the diffraction structure HOE, an optical path difference of about m×λ2 (μm) is generated between the adjacent zones R. Since no actual phase difference is given to the laser beam with the wavelength λ2, the laser beam passes through the diffraction structure HOE without being diffracted. In this specification, a light beam which passes through the diffraction structure HOE because no actual phase difference is given will be referred to as 0th-order diffracted light.

When, e.g., m=5, and the laser beam having the wavelength λ3 (λ3=0.785 μm), which is emitted from the infrared semiconductor laser LD3, enters the diffraction structure HOE of the second collimator L2, an optical path difference of d×(n3−1)−2λ3=0.38 μm is generated between adjacent zones. For the two zones in one zone portion, an optical path difference corresponding to the wavelength λ3 (0.38×2=0.76 μm) is generated. For this reason, wavefronts which have passed through one zone portion overlap with a shift corresponding to one wavelength. That is, the light beam having the wavelength λ3 changes to diffracted light diffracted in the 1st-order direction through the diffraction structure HOE. Note that n3 is the refractive index of the second collimator L2 for the wavelength λ3 (n3=1.503). The diffraction efficiency for the 1st-order diffracted light of the laser beam (wavelength λ3) is 40.3%. The light amount is sufficient for recording/playing back information on/from the CD.

The wavelength selectivity of the diffraction structure HOE when the number of zones R present in one zone portion of the diffraction structure HOE is 2 has been described above. Even in a zone portion in which the number of zones R is not 5, the diffraction structure HOE can give the diffraction effect to the light beam having the wavelength λ3 but not to the light beam having the wavelength λ2 if the depth d in the direction of the optical axis between the optical surfaces F in adjacent two zones R falls within the range of expression (1). When the wavelength selectivity of the diffraction structure HOE is used, the diffraction efficiency of the passing light beam can be increased.

The number of zones R present in one zone portion of the diffraction structure HOE changes depending on the zone portion. As compared to a structure in which the number of zones is the same (e.g., 5) in all zone portions, the number of zones can be decreased. Hence, the decrease in light amount can be suppressed, and the workability of the second collimator L2 having the diffraction structure HOE can be increased.

When the diffraction structure HOE is formed on the second collimator L2 to change the optical system magnification of the objective optical element OBJ between the light beam with the wavelength λ2 and that with the wavelength λ3, spherical aberration caused by the thickness difference between the protective layer PL2 of the DVD and the protective layer PL3 of the CD can be corrected.

As described above, in the optical pickup device PU of the first embodiment, the diffraction structure HOE has a wavelength selectivity so that the diffraction effect is given to the third light beam but not to the second light beam. With this arrangement, even when the objective optical element OBJ has no diffraction structure, a high-density optical disc/DVD/CD compatible optical pickup device which ensures a sufficient light amount and has an aberration correction function can be obtained.

In addition, when the light source unit LU23 in which the second light source LD2 and third light source LD3 are packaged is used, the optical elements of the optical system of the optical pickup device PU can be shared by the second and third light beams. Hence, the optical pickup device PU can be made compact, and the number of components can be reduced.

In the first embodiment, the second collimator L2 outputs the light beam with the wavelength λ2 as parallel light and the light beam with the wavelength λ3 as divergent light. However, the present invention is not limited to this. The second collimator L2 may output both the light beams with the wavelengths λ2 and λ3 as divergent light. Alternatively, the second collimator L2 may output the light beam with the wavelength λ2 as convergent light and the light beam with the wavelength λ3 as divergent light. The first collimator L1 may output the light beam with the wavelength λ1 as convergent light.

Assume that the diffraction structure HOE periodically includes at least two kinds of structures, i.e., a structure in which the number of zones R present in one zone portion is A1 (e.g., 5) and a structure in which the number of zones R is A2 (A2≠A1, e.g., 4), as in the first embodiment. For example, a zone portion having four zones follows a zone portion having five zones. When this combination is repeated in the direction to separate from the optical axis of the second collimator L2, the order of diffraction which ensures the maximum diffraction efficiency for each of the second and third light beams can appropriately be adjusted. Hence, the degree of freedom in designing the lens increases.

As shown in FIG. 3A, of the plurality of zone portions of the diffraction structure HOE, the period width of a zone portion which has the minimum period width in the direction perpendicular to the optical axis is represented by L. Of the plurality of zones R present in the zone portion, a zone which gives the largest optical path length to a passing light beam is defined as the first zone. The width of the first zone in the direction perpendicular to the optical axis is represented by ΔL. The number of zones present in the zone portion is represented by K. At this time, the diffraction structure is preferably designed to satisfy
1/K<ΔL/L≦1/(K−1) (2)

According to this condition, the width ΔL of the first zone R1 in the direction perpendicular to the optical axis is larger than those of the remaining zones (R2 to R5).

Normally, in manufacturing the molding die of the second collimator having the diffraction structure HOE, the width of the flat cutting tool to carve the die is designed to be equal to or larger than the width of each zone. First, the flat cutting tool is moved in the direction of the optical axis at a portion of the die corresponding to the fifth zone R5. When the die is carved in a predetermined amount, the flat cutting tool is slidably moved to the side of the fourth zone to form the portion corresponding to the optical surface of the fifth zone R5. Next, the flat cutting tool. is moved to a portion corresponding to the fourth zone R4. After that, the flat cutting tool is moved in the direction of the optical axis. When the die is carved in a predetermined amount, the flat cutting tool is slidably moved to the side of the third zone to form the portion corresponding to the optical surface of the zone R4. This process is repeated for the third and second zones to form the portion corresponding to the first zone finally. However, in some optical elements, to satisfy the required performance, all zone widths in a zone portion cannot be made larger than the width of the flat cutting tool. As described above, when the width ΔL of the first zone R1 in the direction perpendicular to the optical axis is made larger than those of the remaining zones, the space to move the flat cutting tool in the direction of the optical axis at the portion corresponding to the first zone and, when the die is carved in a predetermined amount, slidably move the flat cutting tool to form the portion corresponding to the optical surface of the first zone can be ensured. Hence, the workability of die manufacturing can be increased. In addition, the decrease in light amount can be suppressed as compared to a case in which the number of zones formed in one zone portion A is decreased to increase the workability of die manufacturing.

The width ΔL of the first zone R1 in the direction perpendicular to the optical axis is preferably set within the range of 0.005 mm≦ΔL≦0.015 mm.

The diffraction efficiency in the second collimator L2 depends on the angle of the light beam incident in the diffraction structure. Hence, the surface which connects the optical surfaces of the adjacent zones is preferably parallel to the incident direction of the light beam. However, when convergent light or divergent light enters the diffraction structure, the incident direction changes depending on the height from the optical axis. To make the incident directions parallel in all zones, the angle of the surface which connects the optical surfaces of the zones must be changed for each zone. From the viewpoint of workability, to obtain a shape to prevent any decrease in diffraction efficiency even when the surfaces which connect the optical surfaces of zones have a predetermined angle in all zones, an angle α (FIG. 3B) of the surface which connects the optical surfaces of adjacent zones with respect to the incident direction of the third light beam having the wavelength λ3 preferably falls within the range given by
0°≦α≦10°

The diffraction structure is expressed by the optical path difference given to the transmission wavefront. Letting h (mm) be the height in the direction perpendicular to the optical axis and C₂ᵢ be the optical path difference function coefficient, the optical path difference is given by an optical path difference function φ=ΣC₂ᵢh²ⁱ (i is a natural number). In addition, a phase function p=2π/λ×φ holds.

Of the plurality of zone portions included in the diffraction structure, for the zone portion close to the optical axis, the phase. function p is expressed by p≈C₂h², i.e., the quadratic equation of h.

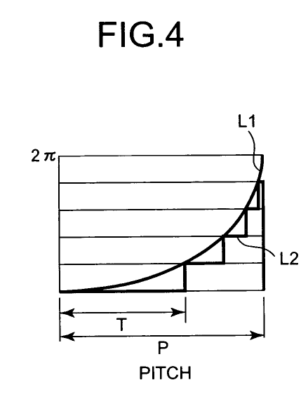

FIG. 4 shows the relationship between the phase function and the phase difference in the diffraction structure HOE of the second collimator lens L2. A curve L1 in FIG. 4 represents the phase function when p≈C₂h². A line L2 represents the phase difference given to the light beam by the zone portion (the number of zones is 5) close to the optical axis. The ordinate of the graph represents the phase difference, and the abscissa represents h. A symbol T indicates the width of the zone in the direction perpendicular to the optical axis; and P, the pitch.

As is apparent from FIG. 4, when the actual phase difference given to each zone matches the phase function, the diffraction efficiency of the light beam passing through the diffraction structure can be increased.

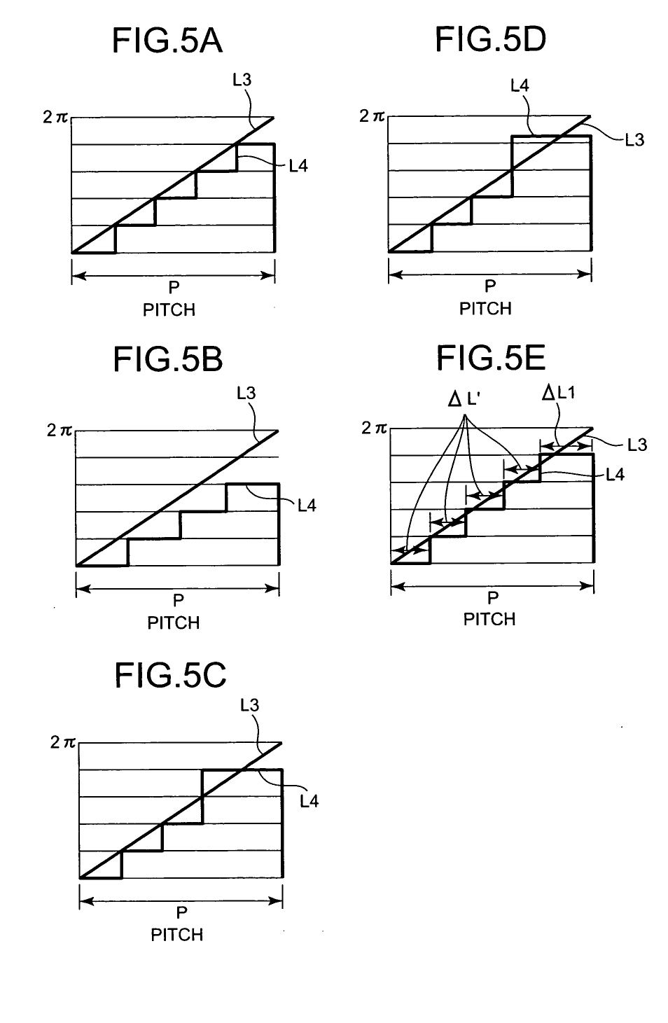

Of the plurality of zone portions included in the diffraction structure, for the zone portion far from the optical axis, the phase function p is expressed by the linear equation of the height h (mm) in the direction perpendicular to the optical axis, as shown in FIGS. 5A to SE.

A line L3 in FIG. 5A represents the optical path difference function when p≈αh (α is a constant) . A line L4 represents the phase difference given to the light beam by the zone portion (the number of zones is 5) far from the optical axis.

As shown in FIG. 5A, when the actual phase difference given to each zone matches the optical path difference function, the diffraction efficiency of the light beam passing through the diffraction structure can be increased.

When the height between adjacent zones in the direction parallel to the optical axis has a value not to always give a phase to passing light (i.e., when the efficiency of passing light is kept), the efficiently for diffracted light can be increased by a structure in which four zones are formed at the same pitch as in FIG. 5A, and all the four zones have the same width, as shown in FIG. 5B rather than a structure in which three zones have the same width, and the uppermost zone has a width corresponding to two zones, as shown in FIG. 5C.

In the technique disclosed in patent reference 4 described above, the 4-zone structure shown in FIG. 5C is employed, and the height of the upper zone is changed, as shown in FIG. 5D. With this structure, the diffracted light efficiency in the region spaced apart from the optical axis is increased while sacrificing the transmission light efficiency to some extent.

However, in the. zone portions of the 4-zone structures as shown in FIGS. 5B to 5D, the diffraction efficiency is lower than the ideal 5-zone structure shown in FIG. 5A.

As shown in FIG. 5E, in one zone portion, the width of the zone, which gives the largest optical path length to a passing light beam, in the direction perpendicular to the optical axis is defined as ΔL1, and the width of the remaining zones in the direction perpendicular to the optical axis is defined as ΔL′. At this time, when the diffraction structure has at least two zone portions to satisfy ΔL′<ΔL1<2ΔL′, the diffraction efficiency can be increased even in the region close to the optical axis.

Here, it should be notified that the aforesaid formulas (1) and (2) are satisfied by the optical element of the present invention which has at least one diffraction period corresponding thereto.

### Detailed Examples

Detailed examples of the optical element described in the first embodiment will be described next.

In the first embodiment, the diffraction structure HOE is formed in the second collimator L2 of the optical pickup device PU as shown in FIG. 1. Two kinds of light beams having the wavelength λ2 for DVD and the wavelength λ3 for CD enter the second collimator L2.

Tables 1 to 4 show the lens data of the optical elements.

TABLE 1

| | | |
|---|---|---|
| Focal length of objective lens | f₁ = 22.4 mm | f₂ = 29.2 mm |
| Magnification | m1: 0 | m2: −1/4.53 |

| ith | | | | | |
|---|---|---|---|---|---|
| surface | ri | di (λ = 655 nm) | ni (λ = 655 nm) | di (λ = 785 nm) | ni (λ = 785 nm) |
| 0 | | ∞ | | −122.50 | |
| 1(stop | ∞ | 17.64 | | 17.64 | |
| diameter) | | (φ 5.164 mm) | | (φ 5.164 mm) | |
| 2 | ∞ | 2.8 | 1.514362 | 2.8 | 1.51108 |
| 3 | ∞ | 0 | 1.0 | 0 | 1.0 |
| 4 | 11.85634 | 1.70 | 1.52915 | 1.70 | 1.52541 |
| 5 | ∞ | 1.70 | 1.0 | 1.70 | 1.0 |
| 5′ | ∞ | 0.00 | 1.0 | 0.00 | 1.0 |
| 6 | ∞ | 6.25 | 1.514362 | 6.25 | 1.51108 |
| 7 | ∞ | | | | |

*di is the displacement from the ith surface to the (i + 1)th surface
*di′ is the displacement from the ith surface to the i'th surface

Aspherical surface, optical path difference function data
4th surface

Aspherical coefficient
κ−1.0020
A4+3.4409×E−5
   5th surface (0 mm≦h≦1.85669 mm)
   Optical path difference function (λB=0.000785 mm)
B2+5.2616×E−3
B4−1.4367×E−5

5'th surface (h>1.85669 mm)

TABLE 2
Zone Start Height (mm)

| No. | 1 | 2 | 3 | 4 | 5 | 6 |
|---|---|---|---|---|---|---|
| 1 | 0 | 0.15732 | 0.222492 | 0.272505 | 0.314672 | 0.351826 |
| 2 | 0.385419 | 0.416313 | 0.445072 | 0.472086 | 0.497639 | 0.521945 |
| 3 | 0.545172 | 0.567451 | 0.58889 | 0.609579 | 0.62959 | 0.648988 |
| 4 | 0.667825 | 0.686149 | 0.704 | 0.721411 | 0.738413 | 0.755036 |
| 5 | 0.771302 | 0.787232 | 0.802848 | 0.818169 | 0.833209 | 0.847985 |
| 6 | 0.86251 | 0.876797 | 0.890856 | 0.904699 | 0.918335 | 0.931774 |
| 7 | 0.045023 | 0.958091 | 0.970985 | 0.983711 | 0.996277 | 1.008688 |
| 8 | 1.02095 | 1.033067 | 1.045045 | 1.056889 | 1.068604 | 1.080192 |
| 9 | 1.09166 | 1.103009 | 1.114244 | 1.125369 | 1.136386 | 1.147299 |
| 10 | 1.15811 | 1.168824 | 1.17944 | 1.189969 | 1.200404 | 1.21075 |
| 11 | 1.22101 | 1.230987 | 1.240963 | 1.25094 | 1.260917 | 1.270893 |
| 12 | 1.28087 | 1.290407 | 1.299943 | 1.30948 | 1.319017 | 1.328553 |
| 13 | 1.33809 | 1.347245 | 1.3564 | 1.365555 | 1.37471 | 1.383865 |
| 14 | 1.39302 | 1.401833 | 1.410647 | 1.41946 | 1.428273 | 1.437087 |
| 15 | 1.4459 | 1.454408 | 1.462917 | 1.471425 | 1.479933 | 1.488442 |
| 16 | 1.49695 | 1.505232 | 1.513514 | 1.521796 | 1.530078 | 1.53836 |
| 17 | 1.54636 | 1.554344 | 1.562328 | 1.570312 | 1.578296 | 1.58628 |
| 18 | 1.59428 | 1.601922 | 1.609704 | 1.617416 | 1.625128 | 1.63284 |
| 19 | 1.64084 | 1.648302 | 1.655764 | 1.663226 | 1.670688 | 1.67815 |
| 20 | 1.68615 | 1.693382 | 1.700614 | 1.707846 | 1.715078 | 1.72231 |
| 21 | 1.73031 | 1.737328 | 1.744346 | 1.751364 | 1.758382 | 1.7654 |
| 22 | 1.7734 | 1.780222 | 1.787044 | 1.793866 | 1.800688 | 1.80751 |
| 23 | 1.81551 | 1.822146 | 1.828782 | 1.835418 | 1.842054 | 1.84869 |

(Note 1)
Nos. 1 to 6 of columns are step Nos. in one zone portion; No. 1 indicates the step closest to the optical axis, and No. 6 indicates the step farthest from the optical axis.
(Note 2)
Nos. 1 to 23 of rows are zone portion Nos.; No. 1 indicates the zone portion closest to the optical axis, and No. 23 indicates the zone portion farthest from the optical axis.

TABLE 3
Zone End Height (mm)

| No. | 1 | 2 | 3 | 4 | 5 | 6 |
|---|---|---|---|---|---|---|
| 1 | 0.15732 | 0.222492 | 0.272505 | 0.314672 | 0.351826 | 0.385419 |
| 2 | 0.416313 | 0.445072 | 0.472086 | 0.497639 | 0.521945 | 0.545172 |
| 3 | 0.567451 | 0.58889 | 0.609579 | 0.62959 | 0.648988 | 0.667825 |
| 4 | 0.686149 | 0.704 | 0.721411 | 0.738413 | 0.755036 | 0.771302 |
| 5 | 0.787232 | 0.802848 | 0.818169 | 0.833209 | 0.847985 | 0.86251 |
| 6 | 0.876797 | 0.890856 | 0.904699 | 0.918335 | 0.931774 | 0.945023 |
| 7 | 0.958091 | 0.970985 | 0.983711 | 0.996277 | 1.008688 | 1.02095 |
| 8 | 1.033067 | 10045045 | 1.056889 | 1.068604 | 1.080192 | 1.09166 |
| 9 | 1.103009 | 1.114244 | 1.125369 | 1.136386 | 1.147299 | 1.15811 |
| 10 | 1.168824 | 1.179444 | 1.189969 | 1.200404 | 1.21075 | 1.22101 |
| 11 | 1.230987 | 1.240963 | 1.25094 | 1.260917 | 1.270893 | 1.28087 |
| 12 | 1.290407 | 1.299943 | 1.30948 | 1.319017 | 1.328553 | 1.33809 |
| 13 | 1.347245 | 1.3564 | 1.365555 | 1.37471 | 1.383865 | 1.39302 |
| 14 | 1.401833 | 1.410647 | 1.41946 | 1.428273 | 1.437087 | 1.4459 |
| 15 | 1.454408 | 1.462917 | 1.471425 | 1.479933 | 1.488442 | 1.49695 |
| 16 | 1.505232 | 1.513514 | 1.521796 | 1.530078 | 1.53836 | 1.54636 |
| 17 | 1.554344 | 1.562328 | 1.580312 | 1.578296 | 1.58628 | 1.59428 |
| 18 | 1.601992 | 1.609704 | 1.617416 | 1.625128 | 1.623284 | 1.64084 |
| 19 | 1.648302 | 1.655764 | 1.663226 | 1.670688 | 1.67815 | 1.68615 |
| 20 | 1.693382 | 1.700614 | 1.707846 | 1.715078 | 1.72231 | 1.73031 |
| 21 | 1.737328 | 1.744346 | 1.751364 | 1.758382 | 1.7654 | 1.7734 |
| 22 | 1.780222 | 1.787044 | 1.793866 | 1.800688 | 1.80751 | 1.81551 |
| 23 | 1.822146 | 1.828782 | 1.835418 | 1.842054 | 1.84869 | 1.85669 |

(Note 1)
Nos. 1 to 6 of columns are step Nos. in one zone portion; No. 1 indicates the step closest to the optical axis, and No. 6 indicates the step farthest from the optical axis.
(Note 2)
Nos. 1 to 23 of rows are zone portion Nos.; No. 1 indicates the zone portion closest to the optical axis, and No. 23 indicates the zone portion farthest from the optical axis.

TABLE 4
Depth of Diffraction Structure for 5th Surface Shape
in Direction Parallel to Optical Axis (mm)

| No. | 1 | 2 | 3 | 4 | 5 | 6 |
|---|---|---|---|---|---|---|
| 1 | 0.006189 | 0.004951 | 0.003714 | 0.002476 | 0.001238 | 0 |
| 2 | 0.006189 | 0.004951 | 0.003714 | 0.002476 | 0.001238 | 0 |
| 3 | 0.006189 | 0.004951 | 0.003714 | 0.002476 | 0.001238 | 0 |
| 4 | 0.006189 | 0.004951 | 0.003714 | 0.002476 | 0.001238 | 0 |
| 5 | 0.006189 | 0.004951 | 0.003714 | 0.002476 | 0.001238 | 0 |
| 6 | 0.006189 | 0.004951 | 0.003714 | 0.002476 | 0.001238 | 0 |
| 7 | 0.006189 | 0.004951 | 0.003714 | 0.002476 | 0.001238 | 0 |
| 8 | 0.006189 | 0.004951 | 0.003714 | 0.002476 | 0.001238 | 0 |
| 9 | 0.006189 | 0.004951 | 0.003714 | 0.002476 | 0.001238 | 0 |
| 10 | 0.006189 | 0.004951 | 0.003714 | 0.002476 | 0.001238 | 0 |
| 11 | 0.006189 | 0.004951 | 0.003714 | 0.002476 | 0.001238 | 0 |
| 12 | 0.006189 | 0.004951 | 0.003714 | 0.002476 | 0.001238 | 0 |
| 13 | 0.006189 | 0.004951 | 0.003714 | 0.002476 | 0.001238 | 0 |
| 14 | 0.006189 | 0.004951 | 0.003714 | 0.002476 | 0.001238 | 0 |
| 15 | 0.006189 | 0.004951 | 0.003714 | 0.002476 | 0.001238 | 0 |
| 16 | 0.006189 | 0.004951 | 0.003714 | 0.002476 | 0.001238 | 0 |
| 17 | 0.006189 | 0.004951 | 0.003714 | 0.002476 | 0.001238 | 0 |
| 18 | 0.006189 | 0.004951 | 0.003714 | 0.002476 | 0.001238 | 0 |
| 19 | 0.006189 | 0.004951 | 0.003714 | 0.002476 | 0.001238 | 0 |
| 20 | 0.006189 | 0.004951 | 0.003714 | 0.002476 | 0.001238 | 0 |
| 21 | 0.006189 | 0.004951 | 0.003714 | 0.002476 | 0.001238 | 0 |
| 22 | 0.006189 | 0.004951 | 0.003714 | 0.002476 | 0.001238 | 0 |
| 23 | 0.006189 | 0.004951 | 0.003714 | 0.002476 | 0.001238 | 0 |

(Note 1)
Nos. 1 to 6 of columns are step Nos. in one zone portion; No. 1 indicates the step closest to the optical axis, and No. 6 indicates the step farthest from the optical axis.
(Note 2)
Nos. 1 to 23 of rows are zone portion Nos.; No. 1 indicates the zone portion closest to the optical axis, and No. 23 indicates the zone portion farthest from the optical axis.
(Note 3)
All the numerical values in the table indicate the direction in which the lens projects.

As shown in Table 1, the collimator of this embodiment is set to focal length f1=22.4 mm and magnification m1=0 when wavelength λ1=655 nm and focal length f2=29.2 mm and magnification m2=−1/1.53 when wavelength λ2=785 nm.

The incident surface of the collimator has a planar shape perpendicular to the optical axis. The heights h about the optical axis are classified into 0 mm≦h≦1.85669 mm for the 5th surface and 1.85669 mm<h for the 5'th surface. The diffraction structure HOE is formed in the 5th surface.

The aspherical shape of the exit surface (4th surface) of the collimator is formed on the aspherical surface axisymmetrical about the optical axis L, which is defined by an equation obtained by substituting the coefficient in Table 1 into equation (I).

$$X ( h ) = \frac{( {h}^{2} / R )}{1 + \sqrt{1 - ( 1 + κ ) {( h / R )}^{2}}} + {\sum }_{i = 0}^{9} + {A}_{2 i} {h}^{2 i} \qquad ( I )$$

where X(h) is the axis in the direction of the optical axis (light traveling direction is defined as positive), κ is the constant of the cone, and A₂ᵢ is the aspherical coefficient.

The diffraction structure HOE is represented by an optical path difference given to the transmission wavefront by this structure. Let h (mm) be the height in the direction perpendicular to the optical axis, B₂ᵢ is the optical path difference function coefficient, n is the diffraction order of diffracted light having the maximum diffraction efficiency in the diffracted light of the incident light beam, λ(nm) be the wavelength of the light beam incident in the diffraction structure, and λB (nm) be the manufacturing wavelength of the diffraction structure. At this time, the optical path difference is represented by an optical path difference function φ(h) (mm) which is defined by substituting the coefficient in Table 1 into equation (II).

$$ϕ ( h ) = ( {\sum }_{i = 0}^{5} {B}_{2 i} {h}^{2 i} ) \times n \times λ / λ B \qquad ( II )$$

A relationship B₂ᵢ×n×λ/λB=C₂ᵢ holds.

Tables 2 to 4 show the shapes and positions of zones included in the diffraction structure HOE.

The diffraction structure HOE will be described with reference to FIGS. 2 and 3A. “Zone portion Nos. 1 to 23” in Table 2 represent the number of zone portions. In this embodiment, 23 zone portions G1 to G23 are present in total. “Zone Nos. 1 to 6” in Table 2 represent the start height (distance from the end close to the optical axis to the optical axis) of the optical surface of a zone (six zones R1 to R6 at maximum) present in each zone portion. Similarly, “zone Nos. 1 to 6” in Table 3 represent the end height (distance from the end far from the optical axis to the optical axis) of the optical surface of a zone (six zones R1 to R6 at maximum) present in each zone portion. Table 4 shows the depth (position in the direction of the optical axis) of the optical surface of each zone for the 5th surface in the direction parallel to the optical axis while defining the direction to project from the 5th surface as positive.

In the zone portions G1 to G10, the zone widths are set such that a phase difference is given along the optical path difference function. In the zone portions G11 to G15, the zone widths are set to be equal. In the zone portions G16 to G23, only the uppermost zone (zone which gives the largest optical path length to a passing light beam) is set to a zone width of 8 μm, and the remaining zones are set to have the same width.

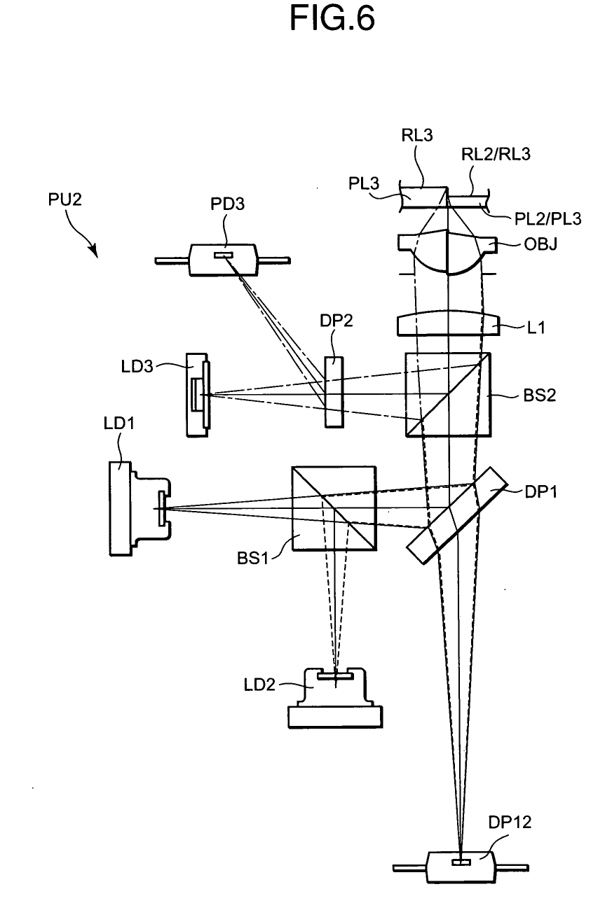

In the first embodiment, the first collimator L1 passes only the first light beam and therefore need not use the above-described wavelength selectivity of the diffraction structure HOE. For example, when the first collimator L1 is arranged between the second beam splitter BS2 and the objective optical element OBJ, the first collimator L1 passes first, second, and third light beams having wavelengths λX, λY, and λZ. An optical pickup device PU2 having an optical system with this arrangement is shown in FIG. 6 as the second embodiment of the present invention.

The second embodiment of the present invention will be described below briefly with reference to FIG. 6.

As is apparent from FIG. 6, in the second embedment, a first collimator L1 is arranged between a second beam splitter BS2 and an objective optical element OBJ. First to third light beams are emitted from independent first light source LD1 to third light source LD3. The first light source LD1 is a blue-violet semiconductor laser for AOD. The second light source LD2 is a red semiconductor laser for DVD. The third light source LD3 is an infrared semiconductor laser for CD.

The first and second light beams share the first beam splitter BS1 and pass through it. The third light beam passes through the second beam splitter BS2 and enters the first collimator L1. The light beams are focused on information recording surfaces RL1/RL2 and RL3 through the objective optical element OBJ. Reference symbol DP denotes a diffraction plate for the first and second light beams; and DP2, a diffraction plate for the third light beam.

In this case, the first collimator L1 has the same function as the collimator L2 of the above-described first embodiment. More specifically, a diffraction structure HOE is formed in the first collimator L1. The first collimator is designed to give the diffraction effect only to the second light beam having a wavelength λY but not to the first and third light beams by using the wavelength selectivity of the diffraction structure HOE.

In the above-described embodiments of the present invention, the diffraction structure HOE is formed in the second collimator L2. However, the present invention is not limited to this. The diffraction structure HOE may be formed in, e.g., the objective lens.

The optical pickup device PU has compatibility between AOD, DVD, and CD by using the first to third light beams. However, the present invention is not limited to this. The optical pickup device may have compatibility between two kinds of optical discs. For example, the blue-violet semiconductor laser LD1, and photodetector PD1, first collimator L1, first beam splitter BS1, and sensor lens SEN1 for the first light beam may be omitted.

1. An optical element which has an optical surface on which a first light beam having a wavelength λx and a second light beam having a wavelength λy, which are emitted from light sources, become incident, comprising:
a diffraction structure in which a plurality of zone portions are formed, the zone portions being arranged in a radial direction about an optical axis and forming one zone portion by a plurality of zones formed into a staircase shape divided by steps in a section including the optical axis,
wherein the plurality of zone portions of said diffraction structure include a first zone portion and a second zone portion whose numbers of zones in one zone portion are different, and of the plurality of zones which form one zone portion, the zones except the zone which gives a largest optical path length to the passing second light beam have at least two different widths in a direction perpendicular to the optical axis, and
of the plurality of zones which form the zone portion, two zones which are adjacent to each other via a step are designed to give no actual phase difference to the first light beam to pass the first light beam and give a phase difference to the second light beam to generate a diffraction effect.

2. An optical element for use in an optical pickup device, comprising:
a diffraction structure in which at least two light beams (a first light beam having a wavelength λX and a second light beam having a wavelength λY) become incident when the optical pickup device is used,
wherein the diffraction structure is so arranged as to cause the second light beam to generate a diffraction effect by giving the second light a phase difference,
wherein the diffraction structure is comprised of a plurality of zone portions which are periodically formed in a radial direction about an optical axis, a plurality of zones having a staircase shape in a section including the optical axis are formed in each zone portion,
wherein a depth d of two zones which are adjacent to each other in each zone portion in a direction of the optical axis is given by
0.96×mX×λX/(nX−1)≦d≦1.04×mX×λX/(nX−1) (1)
where mX: positive integer
nX: refractive index of the optical element for the first light beam having the wavelength λX,
wherein the plurality of zone portions comprising the diffraction structure includes a first zone portion and a second zone portion in which the number of zones formed in one zone portion differ from those in the first zone portion, and
wherein a zone portion is present in which, out of the plurality of zones formed in one zone portion of the diffraction structure, the zones except the zone which gives a largest optical path length to the passing second light beam have at least two different widths in a direction perpendicular to the optical axis.

3. An element according to claim 1, wherein when of the plurality of zones present in one zone portion of said diffraction structure, the zone which gives the largest optical path length to the passing second light beam is defined as a first zone, the number of zones present between the first zones present in two adjacent zone portions changes depending on the zone portion.

4. An optical element for use in an optical pickup device, comprising:
a diffraction structure in which at least one light beam becomes incident when the optical pickup device is used,
wherein the diffraction structure is so arranged as to cause the second light beam to generate a diffraction effect, without transmitting as it is, by giving the second light a phase difference,
wherein the diffraction structure is comprised of a plurality of zone portions which are periodically formed in a radial direction about an optical axis, a plurality of zones having a staircase shape in a section including the optical axis are formed in each zone portion, and
wherein the plurality of zone portions comprising the diffraction structure includes a first zone portion and a second zone portion in which the number of zones formed in one zone portion differ from those in the first zone portion, the first and second zone portions being periodically mixed.

5. An element according to claim 4, wherein a zone portion A is present in which of the plurality of zones present in one zone portion of said diffraction structure, the zones except the zone which gives a largest optical path length to the passing light beam have at least two different widths in a direction perpendicular to the optical axis.

6. An optical element for use in an optical pickup device, comprising:
a diffraction structure in which at least one light beam becomes incident when the optical pickup device is used,
wherein the diffraction structure is so arranged as to cause the second light beam to generate a diffraction effect, without transmitting as it is, by giving the second light a phase difference,
wherein the diffraction structure is comprised of a plurality of zone portions which are periodically formed in a radial direction about an optical axis, a plurality of zones having a staircase shape in a section including the optical axis are formed in each zone portion, and
wherein zone portions of the plurality of zone portions are periodically present as zones about the optical axis, and when of the plurality of zone portions, a period width of a zone portion having a smallest period width in a direction perpendicular to the optical axis is defined as L, the zone which gives a largest optical path length to the passing light beam is defined as a first zone, a width of the first zone in the direction perpendicular to the optical axis is defined as ΔL, and the number of zones present in the zone portion is defined as K,
1/K<ΔL/L≦1/(K−1) (2)
is satisfied.

7. An element according to claim 6, wherein a zone portion A is present in which of the plurality of zones present in one zone portion of said diffraction structure, the zones except the zone which gives the largest optical path length to the passing light beam have at least two different widths in the direction perpendicular to the optical axis.

8. An element according to claim 1, wherein when the widths of the zones present in the zone portion A in the direction perpendicular to the optical axis are defined as T1, T2, T3, . . . , Ti (i is a natural number) sequentially from a side close to the optical axis, T1>T2>T3 > . . . >Ti.

9. An element according to claim 8, wherein letting h be a height of each zone from the optical axis, the width Ti of each zone present in the zone portion A in the direction perpendicular to the optical axis is given by Ti∝[d(ΣC₂ᵢh²ⁱ)/dh]⁻¹ (C₂ᵢ is a coefficient of an optical path difference function).

10. An element according to claim 1, wherein the zone portion A is closest to the optical axis in the plurality of zone portions.

11. An element according to claim 1, wherein when, in one zone portion, the width of the zone, which gives the largest optical path length to the passing light beam, in the direction perpendicular to the optical axis is defined as ΔL1, and the width of the remaining zones in the direction perpendicular to the optical axis is defined as ΔL′, at least two zone. portions which satisfy ΔL′<ΔL1<2ΔL′ are present in said diffraction structure.

12. An element according to claim 6, wherein when, in one zone portion, the width of the zone, which gives the largest optical path length to the passing light beam, in the direction perpendicular to the optical axis is defined as ΔL1, and the width of the remaining zones in the direction perpendicular to the optical axis is defined as ΔL′, a zone which satisfies ΔL1<ΔL′ and a zone which satisfies ΔL1=ΔL′ are mixed.

13. An element according to claim 1, wherein of diffracted light components generated by said diffraction structure when the first light beam having the wavelength λX becomes incident, 0th-order diffracted light has a maximum diffraction efficiency, and of diffracted light components generated by said diffraction structure when the second light beam having the wavelength λY becomes incident, diffracted light except 0th-order diffracted light has the maximum diffraction efficiency.

14. An element according to claim 13, wherein said diffraction structure is optimized for the 0th-order diffracted light of the first light beam.

15. An element according to claim 1, wherein said diffraction structure satisfies
620 nm≦λX≦690 nm
750 nm≦λY≦820 nm
m1=1
and has at least one zone portion group including six zone portions.

16. An element according to claim 15, wherein of diffracted light components generated by said diffraction structure when the first light beam having the wavelength λX becomes incident, 0th-order diffracted light has a maximum diffraction efficiency, of diffracted light components generated by said diffraction structure when the second light beam having the wavelength λY becomes incident, diffracted light except 0th-order diffracted light has the maximum diffraction efficiency, and the diffraction efficiencies fall within a range of 75% to 100%.

17. An element according to claim 15, wherein 0.0012 mm≦d≦0.0014 mm is satisfied.

18. An element according to claim 1, wherein a third light beam having a wavelength λZ further enters said diffraction structure when the optical pickup device is used,
370 nm≦λX≦440 nm
750 nm≦λY≦820 nm
620 nm≦λZ≦690 nm
m1=5
are satisfied, and
said diffraction structure has at least one zone portion group including two zone portions.

19. An element according to claim 18, wherein of diffracted light components generated by said diffraction structure when the first light beam having the wavelength λX becomes incident, 0th-order diffracted light has a maximum diffraction efficiency, of diffracted light components generated by said diffraction structure when the second light beam having the wavelength λY becomes incident, diffracted light except 0th-order diffracted light has the maximum diffraction efficiency, of diffracted light components generated by said diffraction structure when the third light beam having the wavelength λZ becomes incident, 0th-order diffracted light has the maximum diffraction efficiency, the diffraction efficiencies associated with the light beam having the wavelength λX and the light beam having the wavelength λZ fall within a range of 75% to 100%, and the diffraction efficiencies associated with the light beam having the wavelength λY fall within a range of 30% to 100%.

20. An element according to claim 18, wherein 0.0076 mm≦d≦0.0086 mm is satisfied.

21. An element according to claim 6, wherein 0.005 mm≦ΔL≦0.015 mm is satisfied.

22. An element according to claim 3, wherein at least the first light beam having the wavelength λX and the second light beam having the wavelength λY enter said diffraction structure, of diffracted light components generated by said diffraction structure when the first light beam having the wavelength λX becomes incident, 0th-order diffracted light has a maximum diffraction efficiency, and of diffracted light components generated by said diffraction structure when the second light beam having the wavelength λY becomes incident, diffracted light except 0th-order diffracted light has the maximum diffraction efficiency.

23. An element according to claim 3, wherein a wavelength of the light beam which enters said diffraction structure and receives the diffraction effect falls within a range of 750 nm to 820 nm.

24. An element according to claim 4, wherein a wavelength of the light beam which enters said diffraction structure and receives the diffraction effect falls within a range of 620 nm to 690 nm.

25. An element according to claim 4, wherein at least the first light beam having the wavelength λX and the second light beam having the wavelength λY enter said diffraction structure, and the second light beam receives the diffraction effect by said diffraction structure, and
of diffracted light components generated by said diffraction structure when the second light beam having the wavelength λY becomes incident, 0th-order diffracted light has a maximum diffraction efficiency.

26. An element according to claim 1, wherein the optical element main body is formed from a material whose Abbe number for the d line falls within a range of 40 to 60.

27. An element according to claim 1, wherein an angle α of a surface which connects the optical surfaces of adjacent zones with respect to an incident direction of a light beam having a wavelength λ1 satisfies 0°≦α≦10°.

28. An element according to claim 1, wherein letting R be a curvature of the optical surface on which the zone of the optical element is formed in a state without said diffraction structure, and f1 be a focal length for a light beam having a shortest wavelength of the light beams incident on the objective lens, −1.5 mm≦f1/R≦1.5 mm is satisfied.

29. An element according to claim 28, wherein the optical surface of the zone is flat.

30. An element according to claim 28, wherein an incident angle of the light beam having the wavelength λX with respect to a normal to the optical surface of each zone falls within a range of 0° to 10°.

31. An element according to claim 1, wherein the optical element comprises an objective lens included in an optical system of the optical pickup device.

32. An element according to claim 1, wherein the optical element comprises a coupling lens included in an optical system of the optical pickup device.

33. An element according to claim 32, wherein said diffraction structure is formed on an optical surface of the optical element on a side of the light source.

34. An element according to claim 1, wherein when a wavelength of a light beam which enters said diffraction structure and receives no diffraction effect from said diffraction structure is defined as λZ, and a depth d of two adjacent zones in each zone portion of said diffraction structure is given by
0.96×mZ×λZ/(nZ−1)≦D≦1.04×mZ×λZ/(nZ−1) (3)
where mZ: positive integer, nZ: refractive index of the optical element for the light beam having the wavelength λZ,
a zone having mZ which changes depending on the zone portion of said diffraction structure is present.

35. An element according to claim 1, wherein the optical element main body is formed by stacking a material A and material B, which have different Abbe numbers for the d line, and said diffraction structure is formed at an interface between the material A and the material B.

36. An element according to claim 1, wherein a third light beam having a wavelength λZ further enters said diffraction structure when the optical pickup device is used,
370 nm≦λX≦440 nm
750 nm≦λY≦820 nm
620 nm≦λZ≦690 nm
are satisfied,
of diffracted light components generated by said diffraction structure when the first light beam having the wavelength λX becomes incident, 0th-order diffracted light has a maximum diffraction efficiency, of diffracted light components generated by said diffraction structure when the second light beam having the wavelength λY becomes incident, 0th-order diffracted light has the maximum diffraction efficiency, of diffracted light components generated by said diffraction structure when the third light beam having the wavelength λZ becomes incident, diffracted light except 0th-order diffracted light has the maximum diffraction efficiency, and the diffraction efficiencies associated with the light beams having the wavelengths λX, λY, and λZ fall within a range of 60% to 100%.

37. An optical pickup device comprising an optical element of claim 1.

38. An optical pickup device comprising an optical element of claim 2.

39. An optical pickup device comprising an optical element of claim 4.

40. An optical pickup device comprising an optical element of claim 6.
